(19) United States
(12) Patent Application Publication
(10) Pub. No.: US 2006/0214470 A1
(43) Pub. Date: Sep. 28, 2006

(54) Mounting device for joining a vehicle body to attachment elements

(76) Inventor: Jochen Wuest, Huegelsheim (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/538,831

(22) PCT Filed: Oct. 29, 2003
(86) PCT No.: PCT/EP03/11981

§ 371 Date: May 10, 2006

(30) Foreign Application Priority Data
Dec. 12, 2002 (DE) 102 58 027.8

(51) Int. Cl. B60J 7/00

(52) U.S. Cl. 296/187.01

(57) ABSTRACT

In a mounting device for joining a vehicle body to attachment elements, in particular to chassis elements, the mounting device being provided with metallically stable centering pins for insertion into centering openings of the body, the risk of damaging the body originating with the centering pins during joining of the body is to be avoided. To this end, the centering pins consist of a metal basic body and a plastic sleeve mounted thereon so as to be removable like a stocking, each of the free centering pin ends being designed to be curved like a dome.

### BACKGROUND OF THE INVENTION

1. Field of the Invention

The invention relates to a mounting device for joining a vehicle body to attachment elements according to the preamble of patent claim 1.

2. Related Art of the Invention

Such mounting devices are known from DE 37 29 084 C2 and DE 198 15 682 A1 for example.

In relation to the size and the weight of a vehicle body, the centering pins must have relatively great rigidity and strength in order that they perform the centering function in a satisfactory way and moreover cannot be destroyed. For this reason, these centering pins are made of metal and moreover have a relatively large diameter. By virtue of the centering pins being made of metal, the risk exists that, in the event of inaccurate centering operations which are inevitable in practice, the body will be damaged when it is placed onto the centering pins. Such risk of damage is especially great in particular in the case of centering pins with free ends of pointed design.

### SUMMARY OF THE INVENTION

The invention deals with the problem of producing centering pins in a mounting device of the generic type with which the risk of damage as far as the bodies to be placed on them are concerned is avoided. This object is achieved by making the centering pins of a mounting device of the generic type according to the characterizing features of patent claim 1.

Expedient and advantageous developments form the subject of the subclaims.

The invention is based on the general idea of making exclusively those regions of the centering pins from a slightly elastically flexible plastic material and otherwise providing a metal basic body for the rigidity and strength, onto which the synthetic regions can be pushed in a sleeve-like manner preferably in the form of a stocking. Moreover, the free end of the plastic sleeve, which end is formed from the plastic material and can come into contact first with a body to be placed on it, is not of pointed design but designed to be rounded like a dome.

With the plastic outer region of the centering pin being designed in the form of a sleeve-shaped stocking, this plastic part can be pushed onto the basic body made of metal while forming a snap lock. In particular plastics with good slidability are suitable, in order to avoid damage to the body paint. Teflon, for example, is very suitable. On the whole, while the sleeve in the form of the sleeve-shaped stocking is to be designed to be as soft as possible, it is nevertheless to be designed with a certain flexural strength.

### BRIEF DESCRIPTION OF THE DRAWINGS

An illustrative embodiment of the invention is shown in the drawing, in which the sole FIGURE

FIG. 1 shows a longitudinal section through a centering pin.

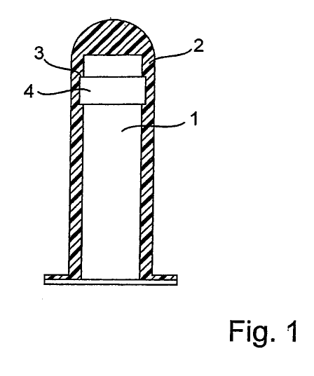

### DETAILED DESCRIPTION OF THE INVENTION

The centering pin consists of a rigid high-strength metal basic body 1 with a cylindrical basic shape. A stocking-shaped plastic sleeve 2 is drawn onto this basic body 1. In this connection, an intimate positive fit exists between the basic body 1 and the plastic sleeve 2.

To increase the strength of the interlocking between the basic body 1 and the plastic sleeve 2, the plastic sleeve 2 is locked on the basic body. The snap lock is formed by an annular groove 3 provided close to the free end of the plastic sleeve 2 and an annular collar 4 of the basic body 1, which collar engages complementarily in the groove in the mounted state. In principle, any other kind of firm interlocking between the basic body 1 and the plastic sleeve 2 is of course also possible.

The free end of the plastic sleeve 2 is designed to be rounded like a dome and is thus also sufficiently stable as a plastic part while nevertheless remaining sufficiently suitable for insertion into the associated centering opening within a vehicle body to be placed on it in a centered manner.

1. A mounting device for joining a vehicle body to attachment elements, in particular to chassis elements, the mounting device comprising:
centering. pins consisting of a metal basic body, and
a plastic sleeve adapted for insertion into centering openings of the vehicle body,
wherein the plastic sleeves (2) are in each case pushed onto one of the metal basic bodies (1) like a stocking and in each case curved like a cap at the centering pin ends, and
wherein in the state when they have been pushed onto a basic body (1), the plastic sleeves (2) are in each case connected to the basic body (1) via a releasable snap lock.

2. (canceled)

3. The mounting device as claimed in claim 1, wherein the plastic sleeve has an open end and a closed end, and wherein the resilient snap lock is formed by an annular groove (3) provided in the plastic sleeve (2) close to the closed end thereof, as well as a cooperating annular collar (4) of the associated basic body (1), which collar engages complementarily in the groove.
